(19) United States
(12) Patent Application Publication
(10) Pub. No.: US 2006/0230866 A1
(43) Pub. Date: Oct. 19, 2006

(54) Steering transmitter assembly for an electric steering system of an industrial truck

(76) Inventors: Frank Manken, Henstedt-Ulzburg (DE); Henrik Schroder, Winsen-Roydorf (DE)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 11/387,559

(22) Filed: Mar. 23, 2006

(30) Foreign Application Priority Data
Apr. 15, 2005 (DE) 10 2005 017 439.6

(51) Int. Cl. B62D 1/20

(52) U.S. Cl. 74/496

(57) ABSTRACT

A steering transmitter assembly for an electronic steering system of an industrial truck, wherein a steering element is coupled to a hub which is rotatably mounted an a bearing component fixed to the vehicle, and wherein an attenuation device is disposed between the bearing component and hub, wherein the hub or bearing component is provided with a gearing portion which is in a driving communication with the pinion of a rotation attenuator and the rotation attenuator, in turn, is located within the bearing component or within the hub in an offset relationship with the axis of rotation of the hub.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

It is known to equip industrial trucks with an electric or electrohydraulic steering system. The steering transmitter such as a steering wheel, a joystick or the like, is coupled to an angle transmitter which mostly is electric and generates an electric signal dependent on the angle of rotation, which is supplied to a steering drive for at least one wheel to be steered. Electric steering transmitters can be very easy to operate, which if a position controller is used will result in the fact that the driver is capable of steering at a faster speed than the actor unit actually moves the steered wheel. This leads to an indirect steering feel and the vehicle's motions tend to become non-dominable.

To avoid the effect described, it is known to use so-called force feedback devices which apply a counterforce to the steering wheel and, thus, prevent the steering wheel from being rotated too fast. However, such a technology involves relative great expenditure.

Further, it is known to make the motion of easy-to-operate steering wheels more difficult to perform by means of a friction brake. A friction brake produces a braking torque which is largely constant and depends on a speed of rotation only to a minimum extent. Therefore, the driver has to apply the same force during each rotational motion of the steering wheel. This does not prevent an excessively fast rotation of the steering wheel sufficiently enough. Furthermore, friction brakes feature the problem of a transition between a higher friction at rest and a lower sliding friction, which makes it necessary initially to overcome a certain start-up torque to move the steering wheel that naturally is higher than is the braking torque when the steering wheel rotates constantly. To prevent such an effect, DE 199 01 451 C3 has made it known for a drawbar-operated steering system to lubricate the friction-exposed surfaces of a friction brake with silicone grease. To avoid or attenuate vibrations in the steering wheel of an automobile, JP 01153379A has made it known to couple a rotation attenuator to the steering shaft of a steering wheel. The shaft has coaxially seated thereon multiple discs which are disposed between coaxial annular discs which, in turn, are coupled to the inside wall of a casing that is fixed to the vehicle and in which a viscous attenuating medium is enclosed. A rotation attenuator of this type has the advantage that viscous friction largely depends on the relative speed. Slow rotational motions are attenuated hardly or little and the attenuation force increases with an increase in the rotational motion.

It is the object of the invention to provide a simply structured attenuation unit for a steering transmitter assembly of the electric steering system in an industrial truck, specifically for steering transmitters having a very small angle of rotation.

### BRIEF SUMMARY OF THE INVENTION

In the inventive steering transmitter assembly, the hub or bearing component is provided with a gearing portion which is in a driving communication with the pinion of a rotation attenuator and the rotation attenuator, in turn, is located within the bearing component, on one hand, or within the hub in an offset relationship with the axis of rotation of the hub.

Rotation attenuators are known for most varied applications in automobile construction or even the furniture industry to attenuate the motion of components in either direction or only a single one. Attenuators exhibit a casing which mostly is cylindrical and in which a rotor is rotatably supported and a viscous attenuating medium, particularly silicone oil, is included. The shaft coupled to the rotor is led out at one end and is provided with a pinion. Such a rotation attenuator can find an application in the invention. Its arrangement has the advantage that the rotation attenuator employed may be relatively small to bring about an efficient attenuation since the gear ratio may be chosen such that even a very small angle of rotation of the steering transmitter results in a sufficient rotation of the rotation attenuator and brings about an efficient attenuation.

The driving communication between the hub and pinion or between the bearing component and pinion can be accomplished via a toothed-belt drive or the like, for example. According to an aspect of the invention, it is beneficial for the gearing portion to be formed by a circular set of teeth which mesh with the pinion.

For an efficiency of attenuation, it does not matter whether the rotation attenuator is coupled to the hub or the bearing component. It is preferred that the rotation attenuator be arranged in a disc-shaped portion of the bearing component. The set of teeth, which are formed within the hub in this case, are preferably formed integrally with the hub made from a plastic.

The inventive steering transmitter assembly can preferably be applied to steering systems in which the angle of hub rotation is limited to less than 360°, preferably 100°, on either side of the neutral position. The neutral position signifies a straight-line ride here.

According to another aspect of the invention, a spring assembly is disposed between the hub and bearing component by which the hub is biased to a neutral position, i.e. a straight-line ride. In another aspect of the invention, a single helical spring disposed coaxially to the axis of rotation is provided the leg ends of which interact with a protrusion of the bearing component and where the hub has a driver portion which interacts with one of the leg ends and subjects the spring to torsion depending on the sense of rotation of the hub.

The inventive steering transmitter assembly can be employed for very different industrial trucks such as low-lift order picker trucks, low-lift industrial trucks with a standing platform, counterweight fork-lift trucks or the like. Furthermore, using it is possible with a further reduced steering angle of 45°, for example, towards either side in so-called narrow-aisle trucks. In this conjunction, according to an aspect of the invention, provision is made for the steering element or hub to be configured blockable in the neutral position. Blocking takes place when the vehicle is running in a storage and retrieval unit aisle.

### BRIEF DESCRIPTION OF THE SEVERAL VIEWS OF THE DRAWINGS

An embodiment of the invention will be described in more detail below with reference to the drawings.

FIG. 1 shows a perspective view of some portion of the steering transmitter assembly with an attenuator according to the invention.

FIG. 2 shows the same perspective view as FIG. 1, but with the hub omitted.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

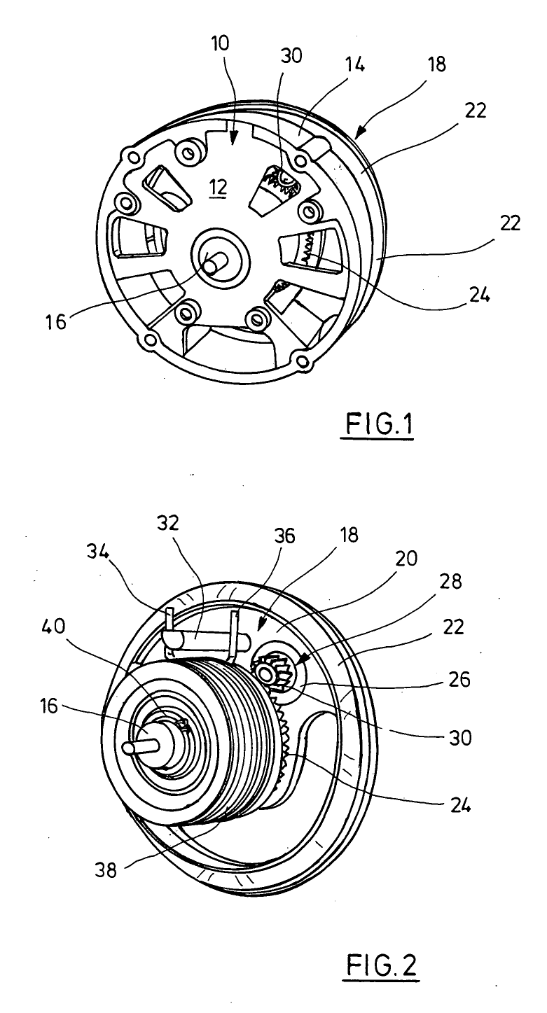

Referring to FIG. 1, a cup-shaped hub 10 can be seen which can be fixedly screwed, for example, to a steering wheel (which is not shown) of an industrial truck (which is not shown either). The hub 10 has a disc-shaped portion 12 and an annular flange 14. The disc-shaped portion 12 is rotatably disposed on a bearing journal 16 which is fixedly coupled to a substantially disc-shaped bearing component 18 (which cannot be recognized). The bearing component 18 has a disc-shaped portion 20 and an outer annular portion 22. A ring-shaped set of teeth 24 is formed with the disc-shaped portion 12 of the hub 10 (the hub 10 being made of a plastic material). The set of teeth 24 are seated coaxially with the axis of rotation of the hub 10 on the bearing journal 16. The disc-shaped portion 20 of the bearing component 18 has eccentrically formed therein a circular opening which fittingly accommodates and locates a flat cylindrical casing 26 of a rotation attenuator 28. The rotation attenuator 28 has a pinion 30 which is arranged on a shaft of the rotation attenuator on which a rotor, which dampingly interacts with a viscous medium inside the casing 26 as is known as such, is fixedly disposed for rotation inside the casing 26.

The pinion 30 meshes with the set of teeth 24 (the hub 10 not being illustrated in FIG. 2, but the set of teeth 24 being shown instead for reasons of representation). Therefore, when the hub 10 rotates the pinion 30 is rotated as well where a relatively small angle of rotation of the hub 10 causes multiple rotations of the pinion 30 because of the gear ratio.

The bearing component 18 is fixedly mounted on the vehicle in a suitable way (which is not shown). Its disc-shaped portion 20 has an axially parallel protrusion 32 which is disposed between two radially bent-away leg ends 34, 36 of a helical spring 38. The helical spring 38 is disposed on the shaft 16. Coupled to the inside of the disc-shaped portion 12 of the hub 10 (not recognizable) is a driver lug which is also engaged between the leg ends 34, 36. When the hub 10 is rotated towards one or the other side the driver lug carries along the associated leg end 34 or 36 and subjects the spring 38 to torsion, which causes the steering wheel to be biased towards the neutral position. The protrusion 32 prevents the spring 38 from being torsioned along.

A washer 40 secures the hub 10 axially on the bearing journal 16.

An electric component which realizes an angle transmitter along with the bearing journal 16, may be attached to the disc-shaped portion of the hub 10.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A steering transmitter assembly for an electronic steering system of an industrial truck, wherein a steering element is coupled to a hub which is rotatably mounted an a bearing component fixed to the vehicle, and wherein an attenuation device is disposed between the bearing component and hub, characterized in that the hub (10) or bearing component is provided with a gearing portion which is in a driving communication with the pinion (30) of a rotation attenuator (28) and the rotation attenuator, in turn, is located within the bearing component (18) or within the hub in an offset relationship with the axis of rotation of the hub (10).

2. The steering transmitter according to claim 1, characterized in that the gearing portion has a circular set of teeth (24) which mesh with the pinion (30).

3. The steering transmitter according to claim 1, characterized in that the bearing component (18) and/or hub (20) has a disc-shaped portion (12) which accommodates the casing (26) of the rotation attenuator (28) in a recess or opening.

4. The steering transmitter according to claim 3, characterized in that the disc-shaped portion (20) of the bearing component (18) has coupled thereto a bearing journal (16) by which the hub (10) is rotatably supported.

5. The steering transmitter according to claim 1, characterized in that a spring assembly is disposed between the hub (10) and bearing component (18) by which the hub (10) is biased to a neutral position.

6. The steering transmitter according to claim 5, characterized in that a single helical spring (30) disposed coaxially to the axis of rotation is provided the leg ends (34, 36) of which interact with a protrusion (32) of the bearing component and the hub (10) has a driver portion which interacts with one of the leg ends (34, 36) depending on the sense of rotation of the hub (10).

7. The steering transmitter according to claim 1, characterized in that the hub (10) is formed in a cup shape and an electric components is disposed on the disc-shaped portion of the hub (10) and, along with a stationary component, defines an angle transmitter.

8. The steering transmitter according to claim 1, characterized in that the angle of rotation of the hub (10) is limited to less than 360°, preferably 100°, on either side of the neutral position.

9. The steering transmitter according to claim 1, characterized in that the steering element or hub (10) is formed to be blocked in the neutral position.
